(19) United States
(12) Patent Application Publication
(10) Pub. No.: US 2008/0250236 A1
(43) Pub. Date: Oct. 9, 2008

(54) Configuration Appliance and Method for Configuration of Electrical Appliances

(75) Inventors: Jurgen Bauereiss, Neustadt a.d. Aish (DE); Rainer Goblirsch, Herzogenaurach (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/088,175

(22) PCT Filed: Sep. 26, 2005
(86) PCT No.: PCT/DE2005/001733

§ 371 Date: Mar. 26, 2008

(51) Int. Cl. G06F 15/177

(52) U.S. Cl. 713/1

(57) ABSTRACT

A parameterization device generates parameterization signals fixing operating parameters for electrical devices of an electrical arrangement. The parameterization device, or configuration device, is particularly user friendly and permits a subsequent alteration of operating parameters for electrical devices which takes little time and is hence particularly economical. The parameterization device is provided with device-specific parameters, individually provided for each device of the arrangement and device-group specific parameters, identically provided for a given group of devices which are differently processed. After changing a stored device-group specific parameter for one of the devices of the relevant group, the changed parameter is copied to the stored parameter sets for the remaining devices of the group on a manual operation input or automatically.

The invention relates to a configuration appliance for production of configuration signals, which define appliance-specific operating parameters, for one or more electrical appliances in an electrical arrangement. In the following text, the expression “configuration” means that predetermined operating parameters are entered in electrical appliances, with the operating parameters defining the method of operation and the functional scope of the appliances; the operating parameters are entered with the aid of configuration signals, which are used to transmit the operating parameters to the appliances.

Nowadays, commercial planning and configuration aids are available for the planning and configuration of electrical arrangements, for example complex electrical installations, such as electrical station control systems, and for the configuration of individual appliances in electrical arrangements such as these, for example protective appliances. One known configuration aid (also referred to in the specialist world as a “configuration tool”) is formed, for example, by the DIGSI configuration program for Siemens AG; after installation on a data processing system, the DIGSI configuration program forms a configuration appliance.

In the case of this already known configuration tool, the respective operating parameters must be predetermined individually for each appliance in the electrical arrangement. If it is found after successfully entering the operating parameters—for example during commissioning—or the test phase of the electrical arrangement that individual operating parameters have been chosen badly or incorrectly, then these operating parameters must be corrected “manually” for each of the affected appliances, using the configuration tool.

The invention is based on the object of specifying a configuration appliance which is particularly user-friendly and in particular allows retrospective modification of the operating parameters of electrical appliances, in a manner that takes up little time and is therefore particularly cost-effective.

According to the invention, this object is achieved by a configuration appliance having the features as claimed in claim 1.

On the basis of a configuration appliance of the type mentioned initially, the invention accordingly provides that the configuration appliance deals differently with appliance-specific parameters which are individually associated with each appliance in the arrangement, and appliance-group-specific parameters which are associated identically with each predetermined group of appliances, in that, after a change to a stored appliance-group-specific parameter for one of the appliances in the respective group, it copies the changed parameters to the stored parameter sets of the other appliances in this group—in response to a manual control input, or automatically. An appliance group may be formed by a subgroup of the appliances in the arrangement, or else by all the appliances in the arrangement.

One major advantage of the configuration appliance according to the invention is that the user need make only a single parameter change input in order to change appliance-group-specific parameters; this is because, when a change command occurs for one of the appliances in the group, the changed appliance-group-specific parameter is changed—either in response to a manual command or automatically—not only in the respective appliance for which the change is carried out but also for all the other appliances in this group which use or process this parameter in an identical manner. The configuration appliance according to the invention therefore means that there is no need to charge an appliance-group-specific parameter repeatedly or even for all the appliances in the respective appliance group. Instead of this, all that is necessary is to define once which parameters are intended to be identical in which appliances; any change to a parameter value for one appliance is then transferred to all the appliances in the respective group, automatically or in response to a manual command.

The association between appliance and appliances groups, and the definition of which parameters for each appliance are appliance-group-specific parameters are preferably defined in advance by means of a configuration module, which is provided for this purpose, for the configuration appliance.

The operating parameters can be entered in the configuration appliance particularly quickly when, when an appliance-group-specific parameter is entered for the first time for one of the appliances, the configuration appliance copies this parameter at this stage to the data records of the other appliances in the respective appliance group. In this case, just a single input is in each case required for each appliance-group-specific parameter for each group.

The appliance-group-specific parameters can be automatically copied particularly easily by in each case defining one of the advances in the group as the “parameter master” for each appliance group. When the parameter for this “chosen” appliance in the appliance group is changed in this case, this parameter is automatically matched in the other appliances in the respective appliance group. A corresponding situation occurs when a parameter value for an appliance-group-specific parameter is entered for the first time for the “chosen” appliance; in this case, this parameter value is automatically transferred to the other appliances in the appliance group.

Alternatively, “parameter copying” can also be initiated automatically when an appliance-group-specific parameter is entered for the first time or is changed for any given appliance in the appliance group. In this case, each appliance in the appliance group effectively acts as the “parameter master”.

By way of example, the following parameters may be used as appliance-group-specific parameters: control language, power supply system frequency, malfunction recording settings (for example fault records), time synchronization settings, jumper settings (for example for control signals as a reaction to incoming messages) and settings for overcurrent time protection or for switch failure protection. Appliances for outgoer panels, appliances for couplings and appliances for feeds to appliance groups are preferably combined since they are normally intended to have identical appliance-group-specific parameters.

In order to simplify parameter group formation and copying of parameter values, it is considered to be advantageous for the parameters to have a standard parameter structure; by way of example, IEC Standard 61850 forms a particularly suitable parameter structure.

In order to allow simple management of the operating parameters, it is considered to be advantageous for the memory device to store a tag for each operating parameter, indicating whether the respective operating parameter is an appliance-specific parameter or an appliance-group-specific parameter. In the case of an appliance-group-specific parameter, information about which appliances belong to which appliance group and therefore make use of the respective parameter identically is preferably additionally stored.

For simple management of the parameters, it is considered to be advantageous for the memory device to store appliance-specific parameters and appliance-group-specific parameters in separate memory areas. For example, the memory device can be provided with a parameter area for appliance-specific parameters and a parameter area for appliance-group-specific parameters respectively, for each parameter set for each appliance.

The invention also relates to a method for production of configuration signals which define appliance-specific operating parameters for electrical appliances in an electrical arrangement, in which operating parameters which are desired at the user end are entered into a memory, and those configuration signals which correspond to the operating parameters stored in the memory device are in each case produced for each appliance selected at the user end.

In order to make a method such as this particularly user-friendly and to allow the operating parameters to be changed retrospectively with little time penalty, the invention proposes that appliance-specific parameters which are specific for each appliance in the arrangement and appliance-group-specific parameters which are intended to be identical for a predetermined group of appliances are dealt with differently in that, after a change to a stored appliance-group-specific parameter for one of the appliances, the changed parameter is copied to the stored parameter sets of the other appliances in the respective group.

With regard to the advantages of the method according to the invention, reference is made to the above statements relating to the configuration appliance according to the invention.

The invention can be used, for example, for station control systems which are equipped with a plurality of field appliances, for example protective appliances. By way of example, in a situation such as this, the configuration appliance according to the invention is connected to at least one of the fields or protective appliances, uses its signal production device to produce the configuration signals, and feeds them to the field or protective appliance.

The invention will be explained in the following text with reference to one exemplary embodiment. In the figures:

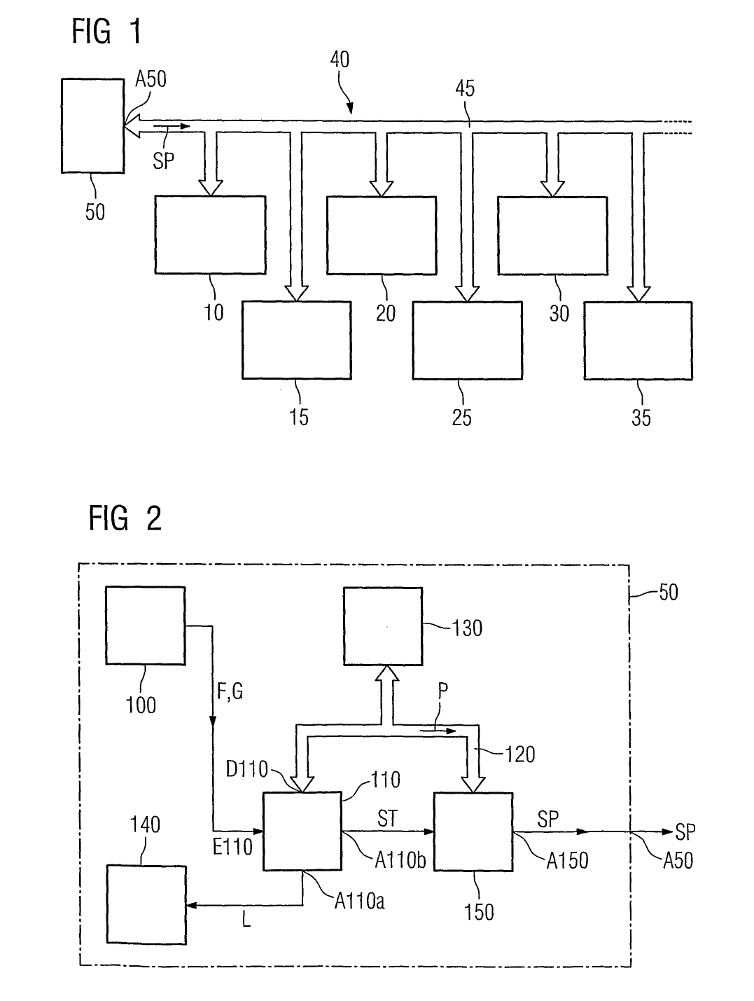

FIG. 1 shows one exemplary embodiment of a station control system according to the invention having a plurality of protective appliances and having a configuration appliance according to the invention connected to it,

FIG. 2 shows one exemplary embodiment of the specific design of the configuration appliance shown in FIG. 1,

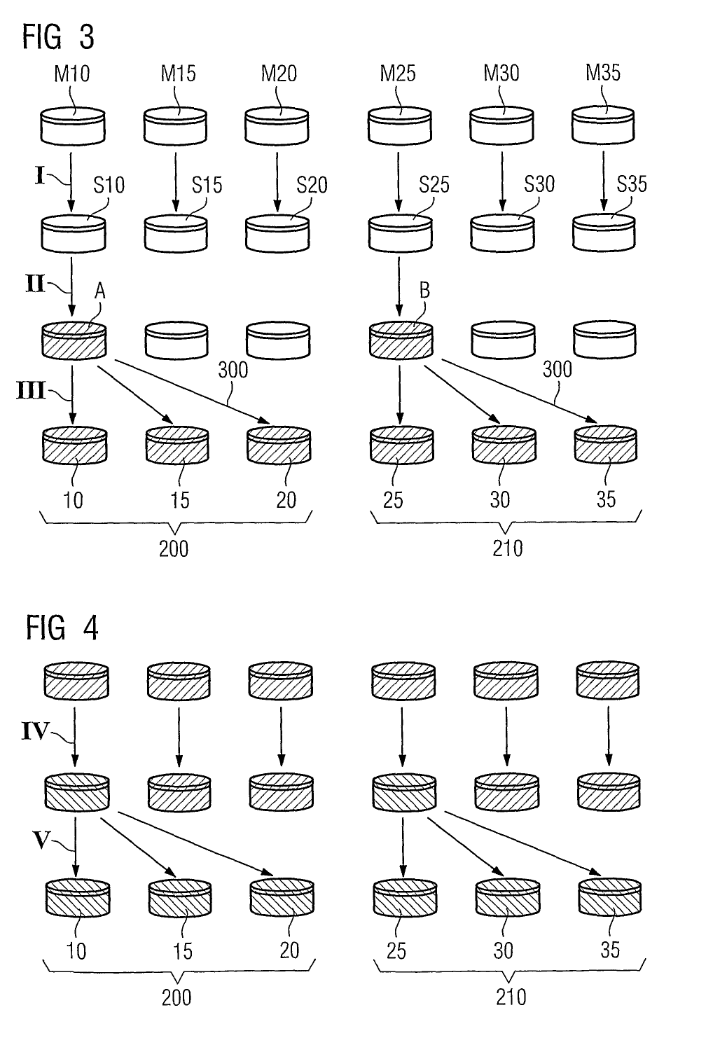

FIG. 3 shows an example of a flowchart illustrating how data records are entered in the configuration appliance shown in FIG. 2, and

FIG. 4 shows an example of a flowchart illustrating a change to a data record in the configuration appliance as shown in FIG. 2.

FIG. 1 shows six protective appliances 10, 15, 20, 25, 30 and 35 which belong to a station control system 40 which is not illustrated in any more detail in FIG. 1. The six protective appliances 10, 15, 20, 25, 30 and 35 are connected to a configuration appliance 50 by means of an external data bus 45. The configuration appliance 50 is used to produce configuration signals SP and to transmit these for configuration purposes to the six protective appliances 10, 15, 20, 25, 30 and 35. The specific functions of the protective appliances 10, 15, 20, 25, 30 and 35 are defined and set by the configuration signals SP.

FIG. 2 shows an example of the design of the configuration appliance 50 shown in FIG. 1. As can be seen, the configuration appliance 50 has an input device 100 which is connected to an input E110 of a processing device 110. The processing device 110 is connected via a data connection D110 to an internal data bus 120, which is connected to a memory device 130.

The processing device 110 is also connected by means of an output A110a and by means of a further output A110b to an output device 140 and to a signal production device 150. An output A150 of the signal production device 150 forms the output A50 of the configuration appliance 50, which is connected to the external data bus 45 as shown in FIG. 1.

The method of operation of the arrangement shown in FIG. 1 and the method of operation of the configuration appliance 50 shown in FIG. 2 will be explained in detail in the following text with reference to FIG. 3:

After setting up a memory area M10, M15, M20, M25, M30 and M35 for each of the six protective appliances 10, 15, 20, 25, 30 and 35 in the memory device 130, the configuration appliance 50 is first of all used to define which parameters of the six protective appliances are appliance-specific parameters and which are appliance-group-specific parameters. Appliance-specific parameters are understood to be those which are individually associated with each protective appliance; appliance-group-specific parameters are those which are in each case identically associated with a predetermined group of appliances.

By way of example, the following text is based on the assumption that the three protective appliances 10, 15 and 20 are intended to be allocated the parameters A1 to An, in each case with the same parameter values. The parameters A1 to An therefore form appliance-group-specific parameters, and a first matching parameter set element A; in this context, the protective appliances 10, 15 and 20 form a first appliance group 200 with matching parameters.

In a corresponding manner, the three protective appliances 25, 30 and 35 form a second appliance group 210; in this second appliance group 210, the parameters B1 to Bm are identical, and form a second parameter set element B.

Furthermore, there may also be other appliance-group-specific parameters which form further parameter set elements for further appliance groups; by way of example, a third appliance group could be formed by the protective appliances 10, 20 and 30, in which different parameters C1 to Cq with identical parameter values are intended to be configured. However, this is not illustrated in any more detail in FIG. 3, for clarity reasons; by way of example, FIG. 3 shows just two parameter set elements A and B, which belong to the two groups 200 and 210. By way of example, the following explanations therefore relate to the two appliance groups 200 and 210.

By way of example, the appliance-specific parameters for each of the protective appliances are first of all defined in a first configuration step I; the reference symbols S10, S15, S20, S25, S30 and S35 in FIG. 3 denote the data records with the appliance-specific parameters.

The appliance-group-specific parameters are entered in a second configuration step II. For this purpose, the first parameter set element A with the appliance-group-specific parameters A1 to An is stored in the protective appliance 10; this is indicated by the reference symbol A in FIG. 3. The second parameter set element B with the appliance-group-specific parameters B1 to Bn is stored in a corresponding manner in the protective appliance 25; this is indicated by the reference symbol B in FIG. 3.

The appliance-group-specific parameters A1 to An and B1 to Bm are then copied to the appliances in the respective appliance group 200 or 210 in the course of a copying step III, in response to a manual input or automatically, that is to say without any need to enter the parameter set elements A or B again. The copying process III is indicated by arrows 300.

If, once the protective appliances have been configured, for example after a test phase IV has been carried out (see FIG. 4), one or all of the appliance-group-specific parameters A1 to An in the parameter set element A is intended to be changed, then there is no need to individually reconfigure all the protective appliances 10, 15, and 20; it is sufficient to change individual parameters, or all of the parameters, in the parameter set element A on the basis of the protective appliance 10, and to copy the changed parameters to the data records for the other protective appliances 15 and 20 (see the copying step V). A corresponding situation applies to changes to the parameter set element B, which are carried out on the basis of the protective appliance 25 and can then be copied to the data records of the other protective appliances 30 and 35 in the second appliance group 210.

The above explanations have been based on the assumption that the parameter set element A and any changes to the parameter set element A are entered with respect to the appliance 10, and that the resultant new parameter set element A is then copied to the data records of the other appliances 15 and 20 in the first appliance group 200. Instead of this, a corresponding input of the parameter set element A or a change to the parameter set element A can also be carried out on the basis of another appliance 15 or 20 in the first appliance group 200 or else “abstractly” for the first appliance group 200 as such.

In a corresponding manner, the parameter set element B can be input and the parameter set element B can be changed on the basis of another appliance 30 or 35 in the second appliance group 210; the selection of the appliance 25 should also be regarded as an example, in this context. Alternatively, the parameter set element B can also be entered or changed “abstractly” for the second appliance group 210 as such.

### LIST OF REFERENCE SYMBOLS

10 Protective appliance

15 Protective appliance

20 Protective appliance

25 Protective appliance

30 Protective appliance

35 Protective appliance

40 Station control system

45 External data bus

50 Configuration appliance

100 Input device

110 Processing device

120 Internal data bus

130 Memory device

140 Output device

150 Signal production device

200 First appliance group

210 Second appliance group

S10 Appliance-specific data record

S15 Appliance-specific data record

S20 Appliance-specific data record

S25 Appliance-specific data record

S30 Appliance-specific data record

S35 Appliance-specific data record

A First appliance-group-specific parameter set element

B Second appliance-group-specific parameter set element

SP Configuration signals

1-9. (canceled)

10. A configuration device for generating configuration signals defining operating parameters of electrical appliances in an electrical system, the device comprising:
an input device configured for receiving input of operating parameters desired at a user end for each of the electrical appliances;
a memory device configured for storing parameter sets in each case for each appliance; and
a signal-generating device configured to generate in each case those configuration signals which correspond to the operating parameters stored in said memory device, for each appliance selected at the user end;
wherein the configuration device is configured to deal differently with appliance-specific parameters individually associated with each appliance in the system, and appliance-group-specific parameters associated identically with each predetermined group of appliances, and, after a change to a stored appliance-group-specific parameter for one of the appliances in the respective group, to copy the respectively changed parameters to the stored parameter sets of the other appliances in the respective group.

11. The configuration device according to claim 10, configured to copy the respectively changed parameters to the stored parameter sets of the other appliances in the respective group upon receiving a manual control input.

12. The configuration device according to claim 10, configured to copy the respectively changed parameters to the stored parameter sets of the other appliances in the respective group automatically.

13. The configuration device according to claim 10, wherein, when an appliance-group-specific parameter is entered for the first time for one of the appliances, the configuration device copies the parameter at this stage to the data records of the other appliances in the respective appliance group.

14. The configuration device according to claim 10, wherein said memory device is configured to store a tag for each operating parameter, indicating whether the respective operating parameter is an appliance-specific parameter or an appliance-group-specific parameter.

15. The configuration device according to claim 10, wherein said memory device is configured to store the appliance-specific parameters and the appliance-group-specific parameters in mutually different memory areas.

16. A method for generating configuration signals defining appliance-specific operating parameters for electrical appliances in an electrical system, the method which comprises:
storing operating parameters desired at a user end; and
generating those configuration signals that correspond with the stored operating parameters in each case for each appliance selected at the user end;
dealing differently with appliance-specific parameters that are specific for each appliance in the system and appliance-group-specific parameters that are intended to be identical for a predetermined group of appliances, and copying, after a change to a stored appliance-group-specific parameter for one of the appliances, the changed parameter to the stored parameter sets of the other appliances in the respective group.

17. The method according to claim 16, which comprises, when a parameter that is defined on an appliance-group-specific basis is entered for the first time, automatically copying the parameter at this stage to the data records of the other appliances in the group.

18. The method according to claim 16, which comprises providing a tag for each operating parameter, indicating whether the respective operating parameter is an appliance-specific parameter or an appliance-group-specific parameter.

19. The method according to claim 16, which comprises storing appliance-specific parameters and appliance-group-specific parameters in separate memory areas.

20. The method according to claim 16, which comprises configuring field appliances in a station control system.

21. The method according to claim 20, which comprises configuring protective appliances.
